(19) United States
(12) Patent Application Publication
(10) Pub. No.: US 2025/0367991 A1
(43) Pub. Date: Dec. 4, 2025

(54) Trailer Wind Mitigation System

(71) Applicant: David Herbert Carlson, Black Hawk, CO (US)

(72) Inventor: David Herbert Carlson, Black Hawk, CO (US)

(21) Appl. No.: 18/731,775

(22) Filed: Jun. 3, 2024

(51) Int. Cl. B60D 1/30

(52) U.S. Cl. CPC B60D 1/30

(57) ABSTRACT

A wind mitigation system can be used on tailers of various sizes. When parked the system can be deployed to offset forces that are oblique or perpendicular to the vehicle by rotating the wings up to 360 degrees in an orientation to generate downward force on the upwind side while simultaneously generating lift on the opposing side. These forces directly oppose the natural forces being generated on the trailer. By counteracting a portion of the force of the wind on the trailer, it will remain upright and undamaged in extreme winds

### CROSS REFERENCE TO RELATED APPLICATIONS

Not Applicable.

### STATEMENT RE: FEDERALLY SPONSORED RESEARCH/DEVELOPMENT

Not Applicable

### BACKGROUND

The various aspects and embodiments described herein relate to a novel trailer wind mitigation system. Semi-trucks are not designed to be aerodynamic in any direction except front facing. This design is with fuel efficiency in mind. When faced with stressors from a perpendicular direction it can be detrimental to the vehicle, driver, and the overall supply chain. Accordingly, there is a need in the art for a prevention system.

### BRIEF SUMMARY

This novel design for prevention of a semi-truck tipping in high-speed winds. When the semi-truck is parked the system will collect data on current conditions and trailer level and deploy the system. The control system will engage the motors to rotate a wing consistent with, and resembling an aircraft wing in shape and adjust the angle of attack to create downforce on the upwind wing, and lift on the downwind wing. The system will adjust the angle of attack in real time to direct the forces to keep the trailer as level as possible and prevent rollover.

### BRIEF DESCRIPTION OF THE DRAWINGS

These and other features and advantages of the various enbodiments disclosed herein will be better understood with respect to the following description and drawings, in which like numbers refer to like parts throughout, and in which:

FIG. 1: is a front elevation view thereof;

FIG. 2: is a right side elevation view thereof;

FIG. 3: is a left side elevation view thereof;

FIG. 4: is a top plan view thereof:

FIG. 5: is a wiring diagram of the system thereof; and

FIG. 6: is a full depiction of the installed system as seen on trailer.

### DETAILED DESCRIPTION

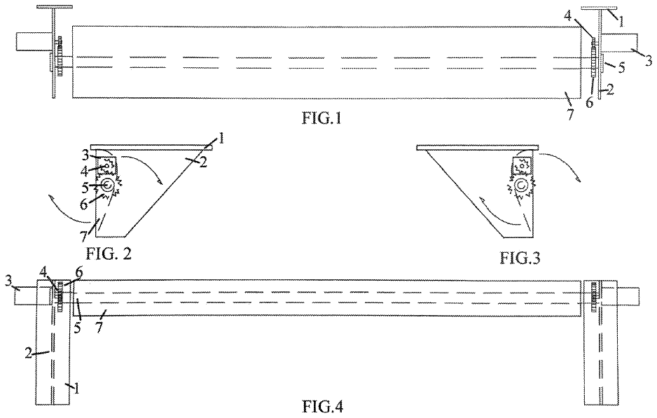

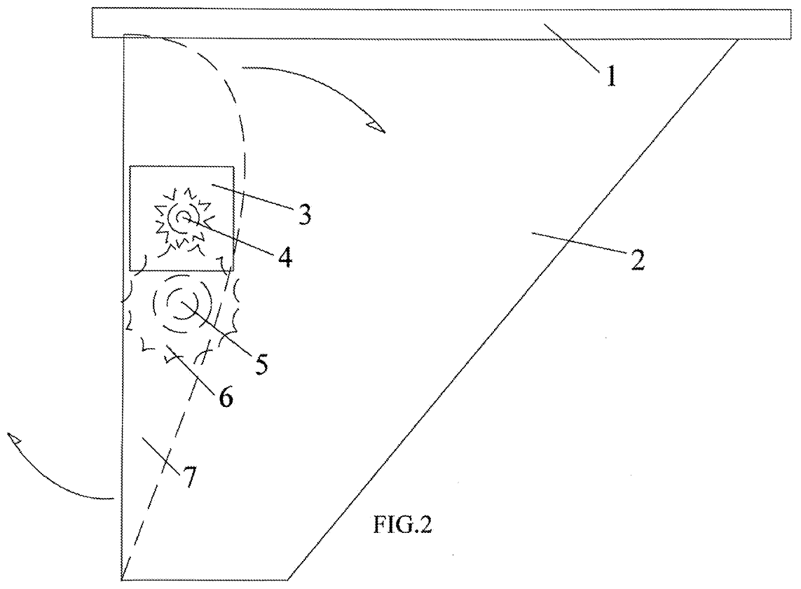

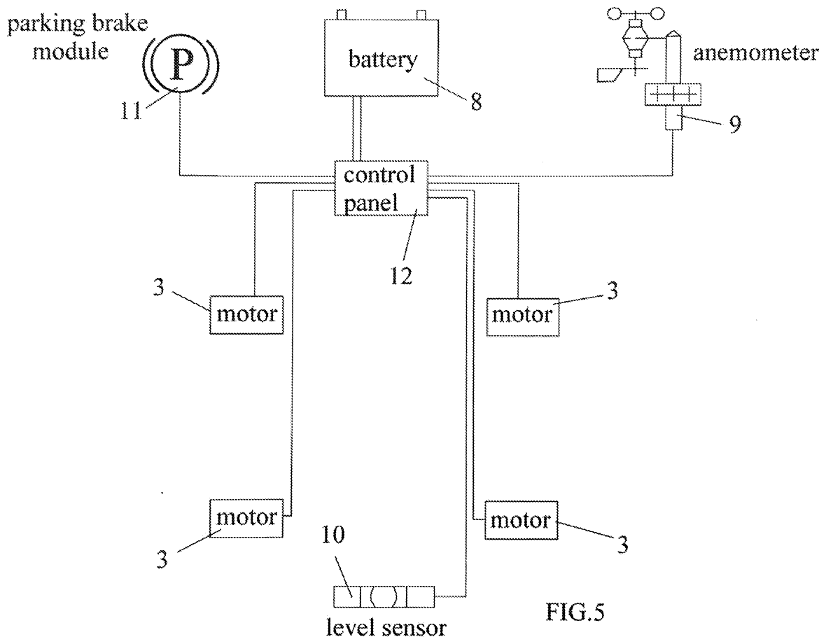

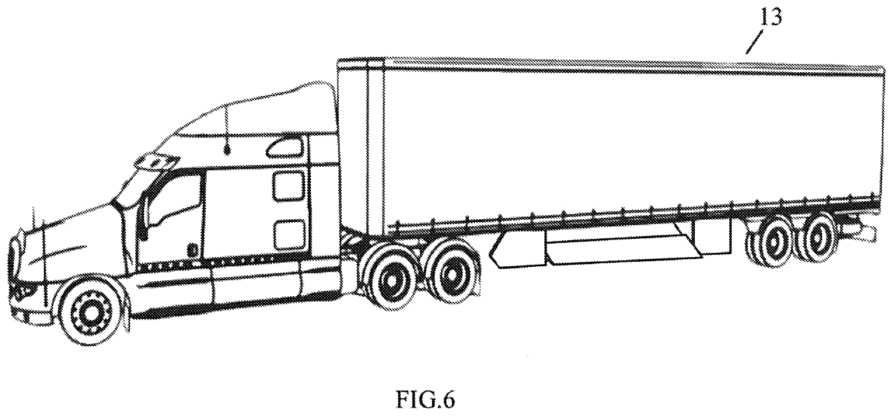

With reference now to the drawings, and in particular to FIGS. 1-6 thereof, a novel trailer wind mitigation system embodiment of the disclosure and generally designated by the reference numeral 13 will be described.

As best illustrated in FIGS. 1-6, trailer wind mitigation system 13 generally comprises of a wing 7 having an aircraft wing aerodynamic shape, having a motor 3, motor gear 4, a center rod 5, a drive gear 6, and side mounting plates 2. When the parking brake is engaged 11 the control panel 12 receives real time wind speed and direction from the anemometer 9 and the angle of the trailer via the level sensor 10. This data will permit the control panel 12 to independently adjust the wings 7 on the right and left side of the trailer, the control panel 12 will send a signal to the motors 3 to adjust the angle of attack based on the data received. The motor gear 4 will engage the wing gear 6 and rotate the wing 7 from the vertical driving position to an appropriate angle of attack with a 360-degree rotation possible as to match wind direction. The wing 7 is stabilized by the center rod 5 which attaches on either end through the side mounting plates 2. The top mounting plate 1 attaches the unit to the underside of the trailer. When returned to the vertical driving position in its rotation will serve as a standard trailer skirt to improve fuel economy.

The above description is given by way of example, and not limitation. Given the above disclosure, one skilled in the art could devise variations that are within the scope and spirit of the invention disclosed herein. Further, the various features of the embodiments disclosed herein can be used alone, or in varying combinations with each other and is not intended to be limited to the specific combination described herein. Thus, the scope of the claims is not to be limited by the illustrated embodiments.

1. An apparatus to prevent trailers from tipping in wind comprising:
an aircraft shaped wing, drive motors, drive gears, motor gears, system control panel, anemometer, level sensor, wing center rod, and mounting plates.
